(19) United States
(12) Patent Application Publication
(10) Pub. No.: US 2025/0073931 A1
(43) Pub. Date: Mar. 6, 2025

(54) COOLING STRUCTURE FOR SERVOMOTOR AND ROBOT

(71) Applicant: FANUC CORPORATION, Minamitsuru-gun, Yamanashi (JP)

(72) Inventor: Ayumu MOTOOKA, Yamanashi (JP)

(73) Assignee: FANUC CORPORATION, Minamitsuru-gun, Yamanashi (JP)

(21) Appl. No.: 18/723,853

(22) PCT Filed: Jan. 26, 2022
(86) PCT No.: PCT/JP2022/002797

§ 371 Date: Jun. 24, 2024

(51) Int. Cl. B25J 19/00

(52) U.S. Cl. CPC B25J 19/0054

(57) ABSTRACT

Provided is a cooling structure for a servomotor, the cooling structure cooling the servomotor fixed to a robot structural body, wherein the servomotor includes a drive unit provided with a stator and a rotor, and an encoder that detects the rotation of the rotor, the cooling structure includes a heat transmission member which is fixed in a state of contact to an outer surface of the stator and a surface of the robot structural body and transmits the heat of the stator to the robot structural body, and the heat transmission member is not in contact with the outer surface of the encoder.

### RELATED APPLICATION DATA

This application is a national phase of International Application No. PCT/JP2022/002797 filed Jan. 26, 2022, which is incorporated herein by reference in its entirety.

### TECHNICAL FIELD

The present disclosure relates to a cooling structure for a servomotor and a robot.

### BACKGROUND ART

In the related art, there is a known robot in which a cooling structure is disposed between a servomotor and a motor housing that accommodates the servomotor in an internal space thereof, in order to cool the servomotor, which generates heat during operation (for example, see Patent Literature 1).

The cooling structure is a thermal conductor that forms a heat conduction path for transmitting heat from the servomotor to the motor housing and that is formed, for example, from a metal such as aluminum.

### CITATION LIST

### Patent Literature

{PTL 1} Japanese Unexamined Patent Application, Publication No. 2014-46398

### SUMMARY OF INVENTION

An aspect of the present disclosure is a cooling structure for a servomotor, the cooling structure cooling the servomotor fixed to a robot structural body, wherein the servomotor comprises a drive unit that comprises a rotor and a stator, and an encoder that detects the rotation of the rotor, the cooling structure includes a heat transmission member fixed in a state of being in contact with an outer surface of the stator and a surface of the robot structural body, the heat transmission member transmitting heat from the stator to the robot structural body, and the heat transmission member is not in contact with an outer surface of the encoder.

### BRIEF DESCRIPTION OF DRAWINGS

FIG. 1 is a partial longitudinal sectional view showing a robot according to an embodiment of the present disclosure.

FIG. 2 is an exploded perspective view for explaining a cooling structure for a servomotor according to an embodiment of the present disclosure, the cooling structure being provided in the robot in FIG. 1.

FIG. 3 is a perspective view showing a state in which the cooling structure for the servomotor in FIG. 2 is assembled.

FIG. 4 is a partial longitudinal sectional view for explaining heat flows in the cooling structure for the servomotor in FIG. 2.

### DESCRIPTION OF EMBODIMENT

A cooling structure 1 for a servomotor 10 and a robot 100 according to an embodiment of the present disclosure will be described below with reference to the drawings.

The robot 100 according to this embodiment is, for example, a vertical articulated robot installed on a floor F.

The cooling structure 1 for the servomotor 10 according to this embodiment is, for example, a structure for cooling the servomotor 10 of a drive mechanism 130 that rotationally drives a revolving drum 120 about a vertical axis with respect to a base 110 fixed to the floor F.

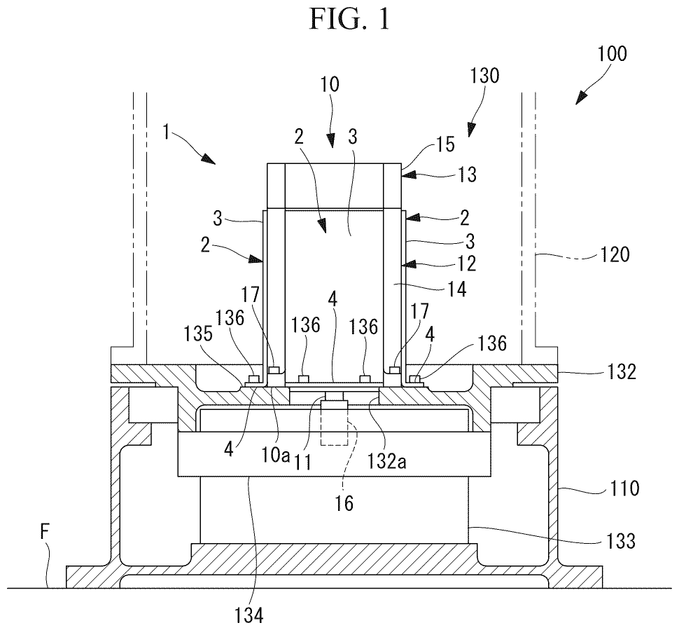

As shown in FIG. 1, the drive mechanism 130 includes: the base 110; a rotary table (robot structural body) 132 that is supported above the base 110 so as to be rotatable about the vertical axis; a reduction gear 133 that is disposed between the base 110 and the rotary table 132; and the servomotor 10 that is fixed to a top surface of the rotary table 132. The revolving drum 120 is fixed to the rotary table 132.

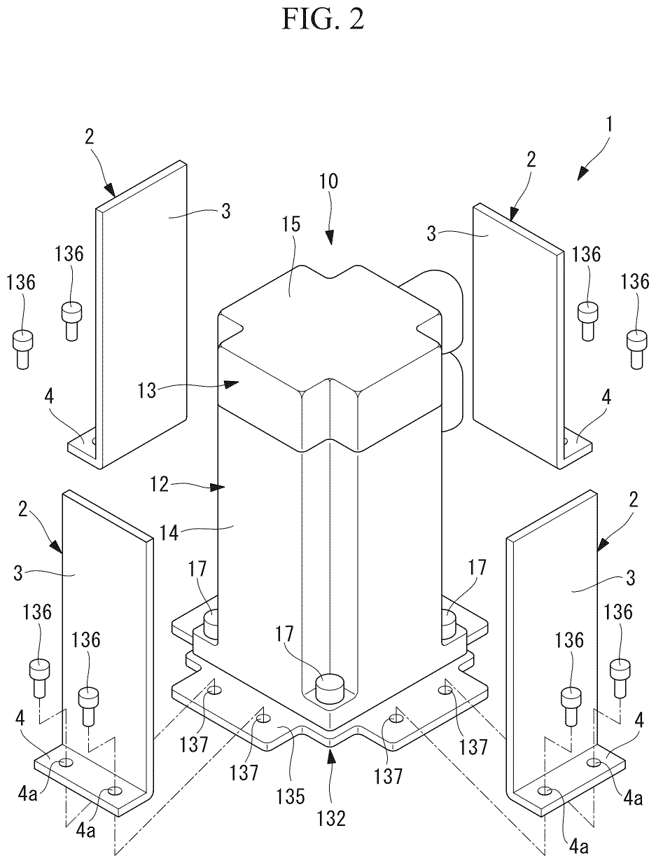

The servomotor 10 includes: a shaft 11; a drive unit 12 that rotationally drives the shaft 11; and an encoder 13 that detects the rotation of the shaft 11. As shown in FIG. 2, the drive unit 12 includes a square cylindrical stator 14 and a rotor (not shown) that is supported inside the stator 14 so as to be rotatable about a central axis of the stator 14, and the rotor is fixed to the shaft 11. The shaft 11 protrudes from an attachment surface 10a provided on one end surface of the stator 14 in the central axis direction.

The encoder 13 includes a box-shaped casing 15 that is fixed to an end surface on the side opposite to the attachment surface 10a with the stator 14 interposed therebetween. The encoder 13 includes a rotation detection mechanism (not shown) and an electronic circuit (not shown) that are accommodated in the casing 15. The casing 15 may be formed of an arbitrary material.

In the servomotor 10, the shaft 11 is made to pass through a through-hole 132a that is provided so as to penetrate the rotary table 132 in a vertical direction, and a gear 16 fixed to the distal end of the shaft 11 is engaged with an input gear 134 of the reduction gear 133. The servomotor 10 is fixed to the rotary table 132 by means of bolts 17 such that the attachment surface 10a is in close contact with a seating surface 135 machined on the top surface of the rotary table 132.

As shown in FIG. 2, the cooling structure 1 for the servomotor 10 according to this embodiment includes four flat plate-shaped heat transmission members (flat plate members) 2 that are respectively brought into close contact with four side surfaces of the stator 14. Each of the heat transmission members 2 includes a motor contact portion 3 that covers the side surface (outer surface) of the stator 14 and that is brought into close contact with said side surface, and a fixing portion 4 for fixing the heat transmission member 2 to the seating surface (surface) 135 on the top surface of the rotary table 132.

The heat transmission member 2 is formed of a material having a high thermal conductivity, for example, a metal such as an aluminum alloy. The heat transmission member 2 may be formed of an arbitrary material. The fixing portion 4 is bent at a right angle with respect to the motor contact portion 3 and includes a plurality of through-holes 4a penetrating therethrough in the plate thickness direction. The heat transmission member 2 is fixed in a state of being in close contact with the rotary table 132 by fastening bolts 136 penetrating through the through-holes 4a of the fixing portion 4 into screw holes 137 provided in the seating surface 135 of the rotary table 132.

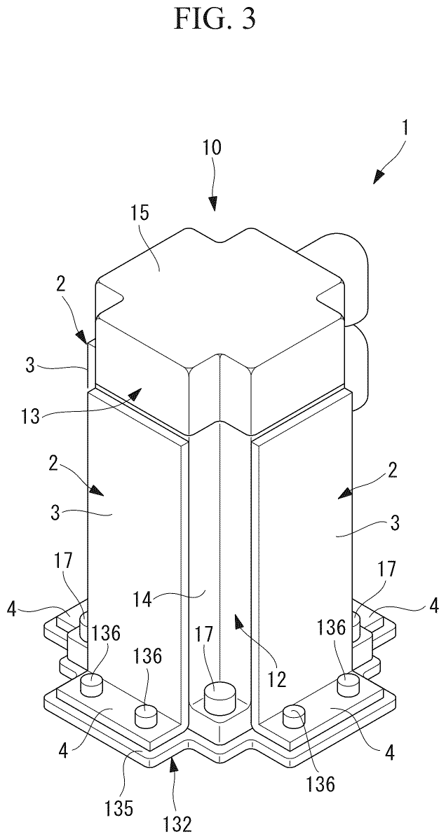

As shown in FIG. 3, the heat transmission members 2 have the motor contact portions 3 in close contact with the respective side surfaces of the stator 14, and also have the fixing portions 4 in close contact with the seating surface 135 of the rotary table 132, thereby forming heat transmission paths for releasing heat generated by the stator 14 to the rotary table 132.

In this embodiment, the motor contact portions 3 of the respective heat transmission members 2 are in close contact with only the respective side surfaces of the stator 14, and are arranged at positions so as not to be in contact with outer surfaces of the casing 15 of the encoder 13. The heat transmission member 2 attached to a side surface provided with a connector has the motor contact portion 3 having a shorter length as compared with the heat transmission members 2 attached to other side surfaces, in order to avoid contact with the connector.

The operation of the thus-configured cooling structure 1 for the servomotor 10 according to this embodiment will be described below.

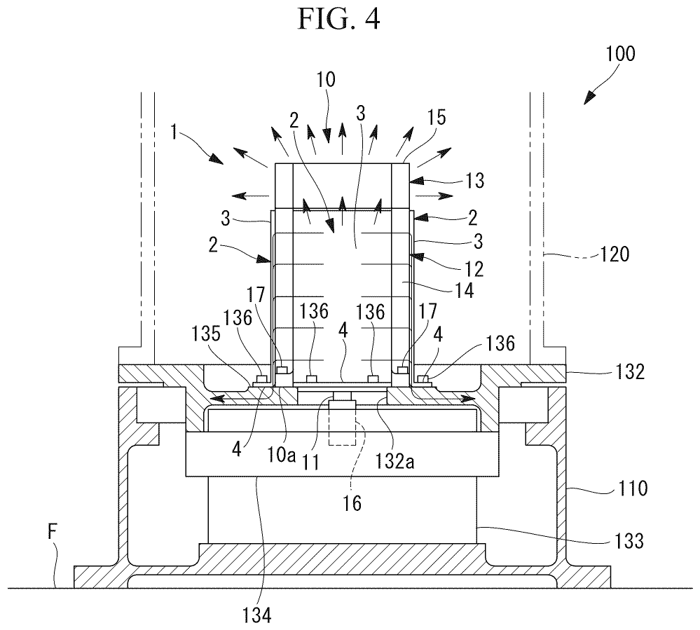

With the cooling structure 1 for the servomotor 10 according to this embodiment, as shown in FIG. 4, when the drive unit 12 including the rotor and the stator 14 generates heat due to actuation of the servomotor 10, a portion of the heat from the drive unit 12 is transmitted to the rotary table 132 via the attachment surface 10a that is in close contact with the seating surface 135.

Furthermore, because the motor contact portions 3 of the heat transmission members 2 are respectively in close contact with the four side surfaces of the stator 14, other portions of the heat from the drive unit 12 are transmitted to the motor contact portions 3. The heat transmitted to the flat plate-shaped motor contact portions 3 is conducted downward along the motor contact portions 3 and is transmitted to the rotary table 132 via the fixing portions 4 that are in close contact with the seating surface 135 of the rotary table 132.

The rotary table 132 has a large heat capacity, and in addition, the stator 14 and the heat transmission members 2 have high thermal conductivity; thus, most of the heat generated in the drive unit 12 is smoothly transmitted to the rotary table 132. As a result, the stator 14 is effectively cooled, and the heat flowing from the stator 14 to the encoder 13 fixed to the stator 14 is sufficiently reduced.

Because the encoder 13 is in contact with only the stator 14, in a case in which the stator 14 has a higher temperature than the encoder 13, the heat from the encoder 13 is dissipated mainly by means of heat transmission to the surrounding air. In other words, because the encoder 13 is not in contact with the heat transmission members 2 for discharging heat from the stator 14, a heat discharge path from the encoder 13 is separated from a heat discharge path from the stator 14. Therefore, even if the temperature rises in the heat transmission members 2 due to the heat discharged from the stator 14, the heat discharge from the encoder 13 is not inhibited.

As a result of the stator 14 being effectively cooled by means of the heat transmission members 2, the amount of heat input from the stator 14 to the encoder 13 is reduced, and thus, the encoder 13 can be sufficiently cooled only by means of heat dissipation to the surrounding air. Although the upper limit of the operating temperature in the encoder 13 is lower than that in the stator 14, the heat discharged from the stator 14 is prevented from flowing into the encoder 13 via the heat transmission members 2; thus, the encoder 13 is maintained at a proper operating temperature.

As a result of the stator 14 being efficiently cooled, in a case in which the encoder 13 has a higher temperature than the stator 14, a portion of the heat generated in the encoder 13 is discharged to the rotary table 132 via the cooled stator 14. In this way also, the encoder 13 can be efficiently cooled.

As described above, with this embodiment, the heat from the stator 14 is conducted downward via the heat transmission members 2, and is discharged to the rotary table 132 located below the stator 14. Therefore, the amount of heat dissipated from the stator 14 to the surrounding air is reduced.

Because the encoder 13 is located above the stator 14, as a result of the heat from the stator 14 being discharged downward, a temperature rise in the air surrounding the encoder 13 is suppressed. With this configuration, the temperature difference between the encoder 13 and the surrounding air is maintained, and thus, there is an advantage in that it is possible to achieve effective heat dissipation from the encoder 13 to the surrounding air.

With the cooling structure 1 for the servomotor 10 according to this embodiment, the flat plate-shaped heat transmission members 2 are arranged along the side surfaces of the servomotor 10 so as to be in close contact therewith. Thus, there is an advantage in that it is not necessary to secure a large installation space around the servomotor 10, which achieves space saving. In addition, the cooling structure 1 can be externally attached by means of a simple attachment method in which the flat plate-shaped heat transmission members 2 are brought into close contact with the side surfaces of the servomotor 10 from the outside thereof, and are fixed to the seating surface 135 of the rotary table 132 by means of the bolts 136. This configuration makes it possible to design the cooling structure 1 after a main mechanism portion is designed, and is advantageous in terms of development and design.

Note that an upright articulated robot has been illustrated as an example of the robot 100 including the cooling structure 1 for the servomotor 10 according to this embodiment. The structure of the robot 100 illustrated in the description of this embodiment is merely one example and is not limited thereto. Although the rotary table 132 has been illustrated as an example of the robot structural body in this embodiment, the cooling structure 1 may be applied to a case in which the servomotor 10 is attached to any other component having a large heat capacity.

Although the flat plate member bent in an L-shape has been illustrated as an example of the heat transmission member 2 in this embodiment, the heat transmission member 2 may have an arbitrary shape according to the seating surface 135 or the like of the rotary table 132, which is the robot structural body to which the heat transmission member 2 is fixed.

Although the heat transmission members 2 are in close contact with all of the four side surfaces of the stator 14 of the servomotor 10 in this embodiment, the heat transmission members 2 may be in close contact with one or more side surfaces of the stator 14.

In order to increase the adhesiveness between the heat transmission members 2 and the outer surfaces of the stator 14, as well as the seating surface 135 of the rotary table 132, a filler, such as a heat conductive gel or a heat transmission sheet, may be interposed between the heat transmission members 2 and the stator 14 and/or the rotary table 132. By doing so, the thermal contact resistance is reduced in the heat transmission from the outer surfaces of the stator 14 to the heat transmission members 2 and in the heat transmission from the heat transmission members 2 to the rotary table 132, and it is possible to perform heat dissipation more smoothly.

Furthermore, in this embodiment, the heat from the stator 14 is moved by means of the heat transmission members 2 in a direction away from the encoder 13. When the temperature of the heat transmission members 2 becomes high, the heat dissipation from the heat transmission members 2 to the surrounding air increases during the heat conduction via the heat transmission members 2.

Accordingly, the outer surfaces of the heat transmission members 2 may be covered with a heat insulating material, such as a heat insulating sheet or a heat insulating coating, for reducing the heat dissipation from the heat transmission members 2 to the surrounding air. By doing so, it is possible to reduce the heat dissipation from the heat transmission members 2 to the atmosphere and to reduce the temperature rise in the air surrounding the encoder 13.

Regarding the servomotor 10, although the configuration in which the encoder 13 is located above the drive unit 12 has been illustrated as an example in this embodiment, the servomotor 10 may be installed in another arbitrary posture. Meanwhile, the cooling mechanism 1 according to the present disclosure is particularly advantageous when the servomotor 10 is in the illustrated posture for the following reasons. Specifically, in a case in which the cooling mechanism 1 is not provided, air expansion occurs after the heat dissipation from the stator 14 to the surrounding air and causes a temperature rise in the air surrounding the encoder 13 that is located in the upper portion. However, with the cooling mechanism 1 according to the present disclosure, the heat dissipation from the stator 14 to the surrounding air is suppressed, and thus, it is possible to maintain the temperature difference between the encoder 13 and the surrounding air.

In addition, because the heat from the encoder 13 is discharged mainly by means of heat dissipation to the surrounding air, a means for promoting heat dissipation may be provided. For example, the casing 15 of the encoder 13 may be provided with a fin, or a fan may be provided to cause a cooling air to flow in the area surrounding the encoder 13. In addition, a heat transmission member for cooling the encoder 13 may be provided separately from the heat transmission members 2 for cooling the stator 14. In addition, a cover or the like may be provided to separate the space in which the encoder 13 is disposed from the space in which the stator 14 is disposed.

### REFERENCE SIGNS LIST

1 cooling structure
2 heat transmission member (flat plate member)
10 servomotor
12 drive unit
13 encoder
14 stator
100 robot
132 rotary table (robot structural body)
135 seating surface (surface)

1. A cooling structure for a servomotor, the cooling structure cooling the servomotor fixed to a robot structural body, wherein
the servomotor comprises a drive unit that comprises a rotor and a stator, and an encoder that detects rotation of the rotor,
the cooling structure comprises a heat transmission member fixed in a state of being in contact with an outer surface of the stator and a surface of the robot structural body, the heat transmission member transmitting heat from the stator to the robot structural body, and
the heat transmission member is not in contact with an outer surface of the encoder.

2. The cooling structure for the servomotor according to claim 1, wherein the heat transmission member is arranged at a position so as to cover the outer surface of the stator and not to cover the outer surface of the encoder.

3. The cooling structure for the servomotor according to claim 1, wherein the servomotor is fixed to the robot structural body in a posture in which the encoder is placed above the stator.

4. The cooling structure for the servomotor according to claim 3, further comprising a heat insulating material that limits heat dissipation from the heat transmission member to surrounding air.

5. The cooling structure for the servomotor according to claim 1, wherein the heat transmission member comprises a flat plate member that is brought into close contact with the outer surface of the stator and the surface of the robot structural body.

6. The cooling structure for the servomotor according to claim 5, wherein the heat transmission member is provided with a filler that promotes adhesion between the flat plate member and the outer surface of the stator or between the flat plate member and the surface of the robot structural body.

7. The cooling structure for the servomotor according to claim 1, wherein the heat transmission member is in close contact with each of two or more outer surfaces of the stator.

8. The robot comprising the cooling structure for the servomotor according to claim 1.
